(19) United States
(12) Patent Application Publication
(10) Pub. No.: US 2006/0143104 A1
(43) Pub. Date: Jun. 29, 2006

(54) Software solution for debt recovery

(76) Inventor: Eliot M. Wagonheim, Timonium, MD (US)

Correspondence Address: Royal W. Craig;Law Offices of Royal W. Craig, Suite 153, 10 N. Calvert Street, Baltimore, MD, 21202, US

(21) Appl. No.: 11/316,774

(22) Filed: Dec. 23, 2005

Related U.S. Application Data
(60) Provisional application No. 60/638,926, filed on Dec. 27, 2004.

(51) Int. Cl. G06Q 40/00

(52) U.S. Cl. 705/35

(57) ABSTRACT

An improved and automated software system that allows inexperienced users to service debts, and quickly increases debt servicer effectiveness while decreasing the time and expense necessary to process a collection effort in accordance with ever-changing court forms and regulations. UCC-compliance, etc., thereby adding consistency and quality to a businesses' collection efforts. The core of the system is a software solution that includes a graphical user interface, which facilitates a collection program, including collection and maintenance of data population of a database, and implementation of the collection process. The interface includes a guided interview which allows a debt servicer to answer questions, and which then implements predetermined collection options by generating all necessary forms and providing implementation FAQs for the user. The user may bypass the guided interview for direct access to the forms via an embedded word processing capability.

### CROSS-REFERENCE TO RELATED APPLICATION(S)

The present application derives priority from U.S. Provisional Application No. 60/638,926, filed 23 Dec. 2004.

### BACKGROUND OF THE INVENTION

1. Field of the invention

The present invention relates generally to delinquent-debt recovery systems and, more particularly, to a software solution for comprehensive management of a debt collection program by business owners, managers, department heads, collection professionals, or others with responsibility for accounts receivable servicing.

2. Description of the Background

Every business that sells product or services will inevitably face debt collection issues. These are best resolved by laying a solid foundation: a debt collection program inclusive of sound internal policies and the best tools to implement those policies. A good program encompasses proper invoicing, creation of account agreements, and developing terms and conditions which protect a business without scaring off customers. Despite even the best foundation, certain customers still refuse to pay on time. They ale usually met with a progression of collection letters followed by litigation (a lawsuit, a judgment, and enforcement of the judgment). Unfortunately, success in the litigation-oriented steps requires special expertise not commonly within the grasp of the plaintiff. Moving a case through a District Court system is a forms-driven process, requiring forms that comply with ever-changing state rules. The common solution is to hire a collection attorney, which often provides at result that doesn't quite justify the cost. There are collection agencies, but they typically only pursue a debt by a letter-writing campaign.

In most cases, the only economical way that a company can turn overdue accounts into receivables is to pursue them in house. In this case there are very few resources to help. A few books exist, such as the present inventor's own “The Art of Getting Paid: The Business Owner's Guide to Managing Receivables and Collecting Debts in Maryland”, Wagonheim, Eliot (1996). There are software solutions, but they are designed for collection agencies to manage numerous letter-writing campaigns. They are geared toward experienced collection agents, and they leave off when it comes to filing suit. It would be greatly advantageous to provide a debt collection software solution for use in-house by employees that organizes and tracks debt collection efforts, and in a broader sense instills a solid debt collection program of policies and practices.

### SUMMARY OF THE INVENTION

The present invention solves the above problems by providing a debt servicing system comprising a software solution for problem-account management, including fully integrated analytical tools to create a unified debt collection effort.

The core of the system is a software solution that includes a graphical user interlace, which facilitates a collection program, including the collection and maintenance of data, population of a database, and implementation of the collection process. The software implements the collection program pursuant to the following steps:
1. A guided interview in which the debt servicer is asked questions about the nature of the debt due, the type of work performed or the type of goods sold, the person or company who owes the money, and the terms of the transaction. The debt servicer answers questions simply by checking off boxes, selecting buttons, or filling in dates and text. The software compiles the information into a database.
2. Upon collecting case information from the guided interview, the software presents the debt servicer with several predetermined collection options ranging from less aggressive (a “friendly” collection letter) to more aggressive (a “final” collection letter, with a threat of further legal action) to serious (filing a lawsuit), collects all necessary data, validates the data, guides the options in accordance with legal constraints, and generates all necessary forms for mailing or filing.
3. Direct access to the forms (bypassing the guided interview) via an embedded word processing capability for direct completion.
4. Implementation. The software administers implementation of the selected collection option inclusive of letter-drafting, litigation, and collecting on a judgment after winning the lawsuit, and calendaring of critical dates.

The system as a whole increases debt servicer effectiveness while decreasing the time and expense necessary to process a collection effort, which translates into heretofore unattainable debt collection workout efficiency. The system also renders on-demand reports of debt collection progress, ensures compliance for ever-changing court forms and regulations facilitates UCC-compliant communication between the debt servicer and delinquent party, and instills consistency in a businesses' collection efforts.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a general overview of the software method collection steps.

FIG. 2 is amore detailed flow chart of the software mechanics which implement the three basic method steps of FIG. 1.

FIG. 3 is a screen print of the graphical user interface inclusive of menu bar 10 which appears immediately after Login

FIG. 4 is a screen print of the begin new case user-interface.

FIG. 5 is a screen print of the interview start screen.

FIG. 6 is a screen print of the “Reminder” pop-up screen.

FIG. 7 is a screen print of the next array of debtor information questions following FIG. 5.

FIG. 8 is a screen print of the word processing section 60.

FIG. 9 is a screen print of the navigable monthly calendar.

FIGS. 10a-e illustrate the database arrangement.

### DETAILED DESCRIPTION OF THE PREFERRED EMBODIMENTS

The present invention is a software solution that includes a graphical user interface, which facilitates a collection program, including the collection and maintenance of data, population of a database, selection of a collection process, implementation by correspondence and legal forms generation, and tracking.

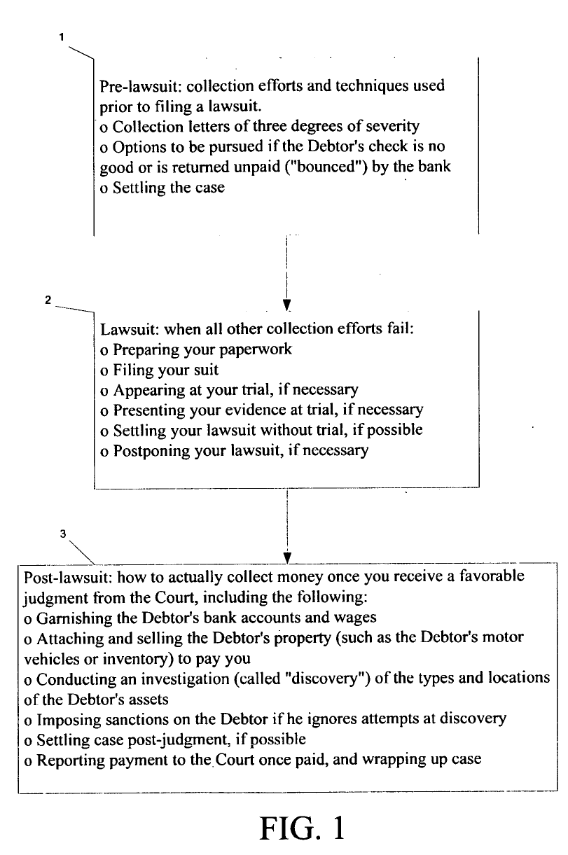

FIG. 1 is a general overview of the software method which is basically divided into 3 discrete collection steps:

Step 1. Pre-lawsuit: this step implements collection efforts and techniques used prior to filing a lawsuit. The features of this step include:
Collection letters of three (3) degrees of severity
Options to be pursued if the Debtor's check is no good or is returned unpaid (“bounced”) by the bank
Settling the case

Step 2. Lawsuit: implementation of lawsuit if collection efforts (Step 1) fail.

The features of this step include:
Preparing the paperwork
Filing suit
Appearing at trial, if necessary
Presenting evidence at trial, if necessary
Settling lawsuit without trial, if possible
Postponing lawsuit, if necessary

Step 3. Post-lawsuit: actually collecting the money once a favorable judgment from the Court is attained. The features of this step include:
Garnishing the Debtor's bank accounts and wages
Attaching and selling the Debtor's property (such as the Debtor's motor vehicles or inventory) to pay you
Conducting an investigation (called “discovery”) of the types and locations of the Debtor's assets
Imposing sanctions on the Debtor if he ignores attempts at discovery
Settling case post-judgment, if possible
Reporting payment to the Court once paid, and wrapping up case

The method steps are readily implemented in software form for use on a conventional computer workstation with an appropriate operating system. The computer workstation may be, for example, a conventional personal computer with standard internal components (e.g. a microprocessor with peripheral chipset mounted on an appropriate motherboard). Of course, other more or less powerful computer systems can be used, but it is suggested that the computer system meet the minimum system requirements for Microsoft® Excel®, or an equivalent spreadsheet software application. The user interface is preferably a conventional color monitor and standard input devices such as a keyboard and mouse. The operating system is preferably Microsoft® XP, any revision. In its presently preferred embodiment the software is compressed onto one or more installation disks and may be loaded onto a computer system as described above using conventional installation macros such as those provided with the aforementioned operating system. However, one skilled in the art will readily understand that the software may be delivered in other ways, such as through an application service provider (ASP) architecture, by download, etc.

The system as a whole increases debt servicer effectiveness while decreasing the time and expense necessary to process a collection effort, which translates into heretofore unattainable debt collection workout efficiency. The system also renders on-demand reports of debt collection progress, ensures compliance for ever-changing court forms and regulations, facilitates UCC-compliant communication between the debt servicer and delinquent party, and instills consistency in a businesses' collection efforts. The above-described steps are described below in more detail in the context of a walk-through of the actual software.

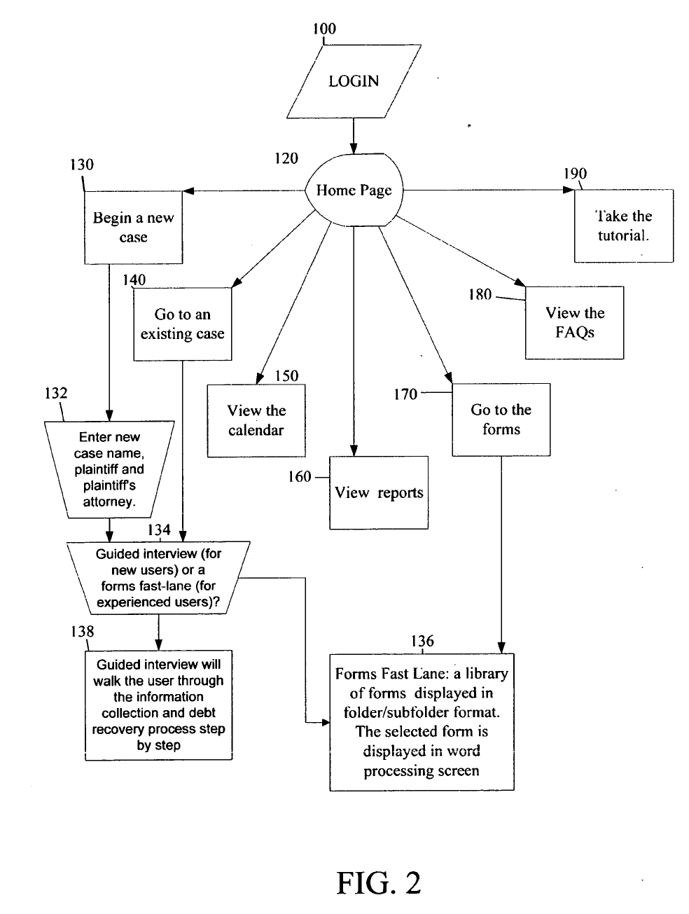

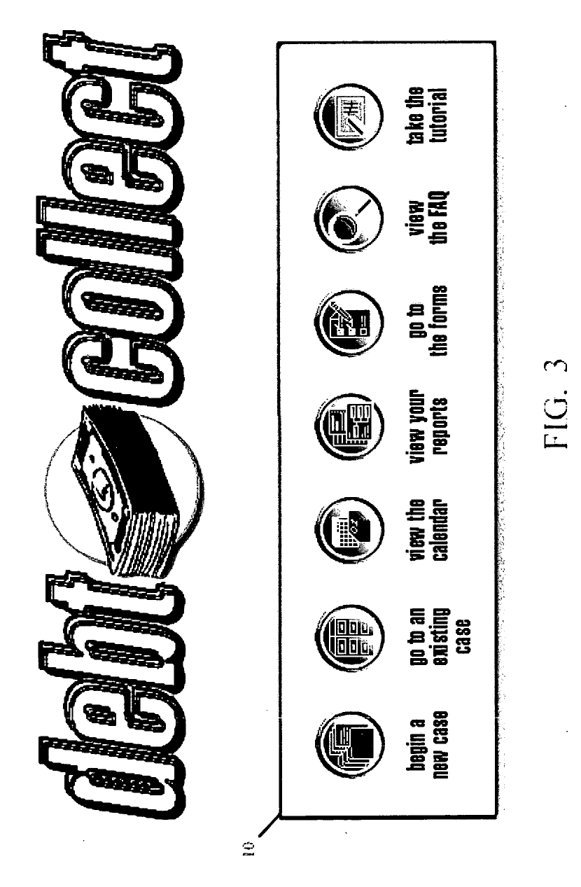

FIG. 2 is amore detailed flow chart of the software mechanics which implement the three basic method steps of FIG. 1.

At step 100, initially, upon executing the software, users are directed to a Login Page with prompts for username and password, and they must enter their username and password to gain access. The user may alter their password if desired. At step 120 the user is directed to a graphical user interface Home Page which serves as a gateway to subsequent steps: step 130) begin a new case; 140) go to an existing case; 150) view the calendar; 160) view reports; 170) go to the forms; 180) view the FAQs; 190) take the tutorial.

FIG. 3 is a screen print of the graphical user interface inclusive of menu bar 10 which appears immediately after Login. The menu bar 10 comprises a series of action buttons: 1) begin a new case; 2) go to an existing case; 3) view the calendar; 4) view reports; 5) go to the forms; 6) view the FAQs; 7) take the tutorial as above. To begin a new case the appropriate button is pressed and the method proceeds to step 130 (FIG. 2) as follows:

Step 130: Begin a New Case

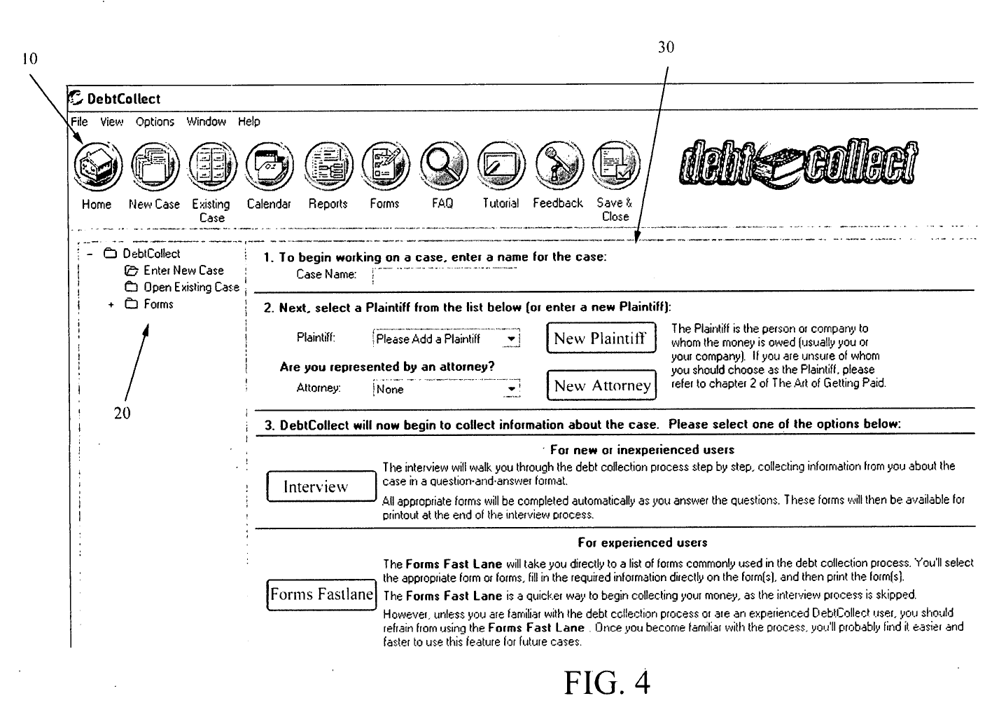

FIG. 4 is a screen print of the begin new case user-interface displayed, which retains the same action buttons 10 up top for easy access from anywhere in the program. To the left the user's program navigation trail 20 is displayed in folder/subfolder format to show the user where he has been and to allow easy backing up. To the right bottom, a form field 30 is displayed with a plurality of sections numbered 1-3 to prompt the user to enter certain new case information along with essential debt recovery information. This information is presented in a step-by-step format to impress the collection process on the user.

At step 132 of FIG. 2, and using section (1.) of FIG. 4, a new case name is entered in order to docket the file. At section (2.), the user designates the plaintiff and enters plaintiff's attorney. This information can be entered by drop down lists of previously-entered database information, or from scratch using form fields. At step 134 of FIG. 2 and section (3) of FIG. 4 the program gives the user a choice as to how to collect detailed information about the case. The choice between a guided interview (for new users) or a forms fast-lane (for experienced users). If the user selects the guided interview option, the software begins a series of screens that will walk the user through the information collection and debt recovery process of FIG. 1 step-by-step, each screen including a detailed explanation. In contrast, the forms fast lane is a more direct way of tilling out the necessary forms for collection by direct data entry into screen representations of the forms themselves.

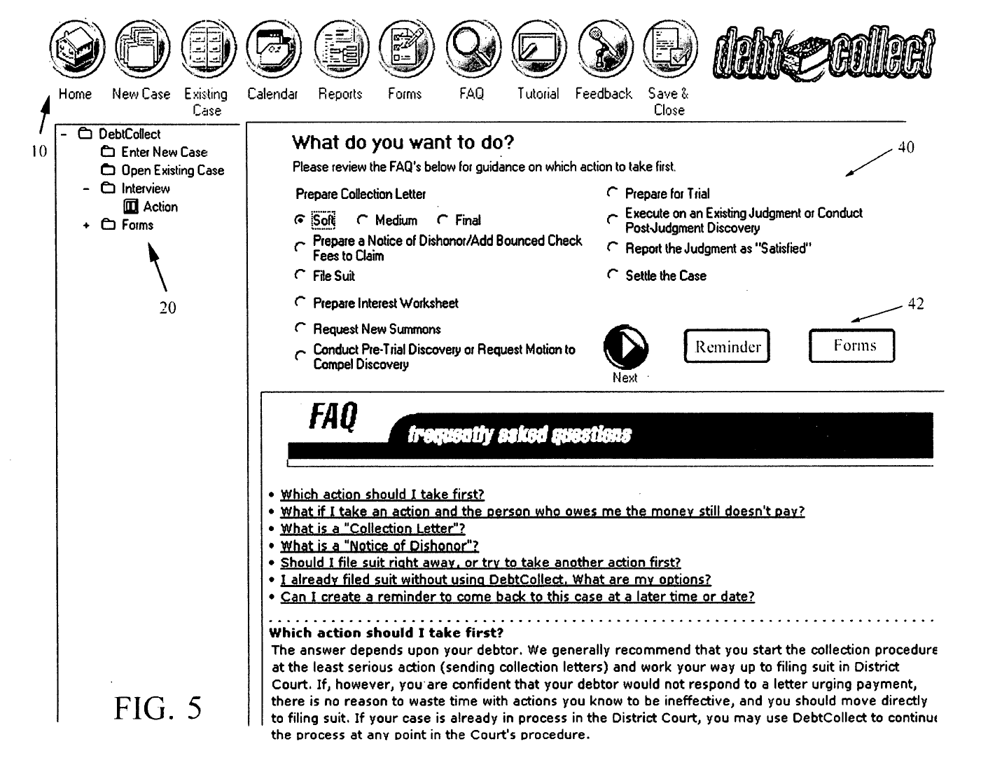

If the guided interview option is selected the software proceeds to step 138 (FIG. 2) where the user is presented with the interview start screen of FIG. 5. This screen retains the basic structure with action buttons 10 up top for easy access, and the user's program navigation trail 20 displayed at right in folder/subfolder format to show the user where he has been and to allow easy backing up. In the upper right a decision checklist 40 is presented with navigation controls 42. The decision checklist 40 presents an array of questions designed to achieve focus, beginning very broadly with “What do you want to do?” The checklist answers include the options that are possible with the software, inclusive of “Prepare Collection Letter” and whether it is to be “Soft”, “Medium” or “Final”. Other options include “Execute on an Existing Judgment”, “Conduct Post-Judgment Discovery”, “Prepare for Trial”. “Prepare a Notice of Dishonor/Add Bounced Check Fees to Claim”, “Report the Judgment as Satisfied”, “File Suit”, “Prepare Interest Worksheet”. “Request New Summons”, and “Conduct Pre-Trial Discovery or Request Motion to Compel Discovery”. Directly beneath in the window at bottom right is a FAQ Screen 50 which provides advice on the choices in decision checklist 40. Thus, each decision is always visible in conjunction with advice to assist the user in the interview. For example, when the user is faced with “Which action should I take first?,” the following advice is offered: “The answer depends upon your debtor. We generally recommend that you start the collection procedure at the least serious action (sending collection letters) and work your way up to filing suit in District Court. If, however, you are confident that your debtor would not respond to a letter urging payment, there is no reason to waste time with actions you know to be ineffective, and you should move directly to filing suit. If your case is already in process in the District Court, you may use DebtCollect to continue the process at any point in the Court's procedure.” This both guides and comforts the user. The navigation controls 42 include “Next” to proceed to the next decision checklist 40, “Reminder” which allows the user to create a reminder to perform a given step, and “Forms” which allow the user to switch over to the forms-based process without the guided interview.

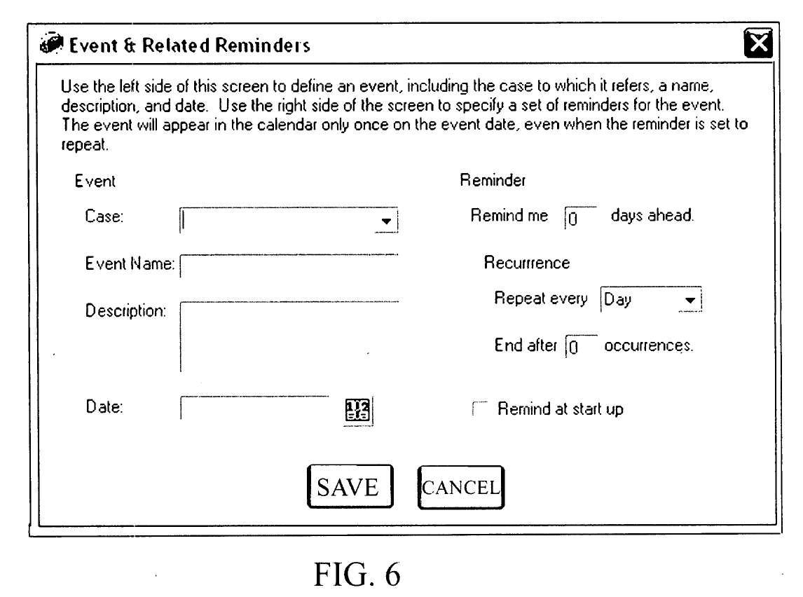

If the user presses “Reminder” the pop-up screen of FIG. 6 arises. The user fills in the side to define an event, including the case to which it refers, a name, description, and date. The right side of the screen is filled in to specify a set of reminders for the event. Once this is completed the reminders will appear in a calendar (to be described).

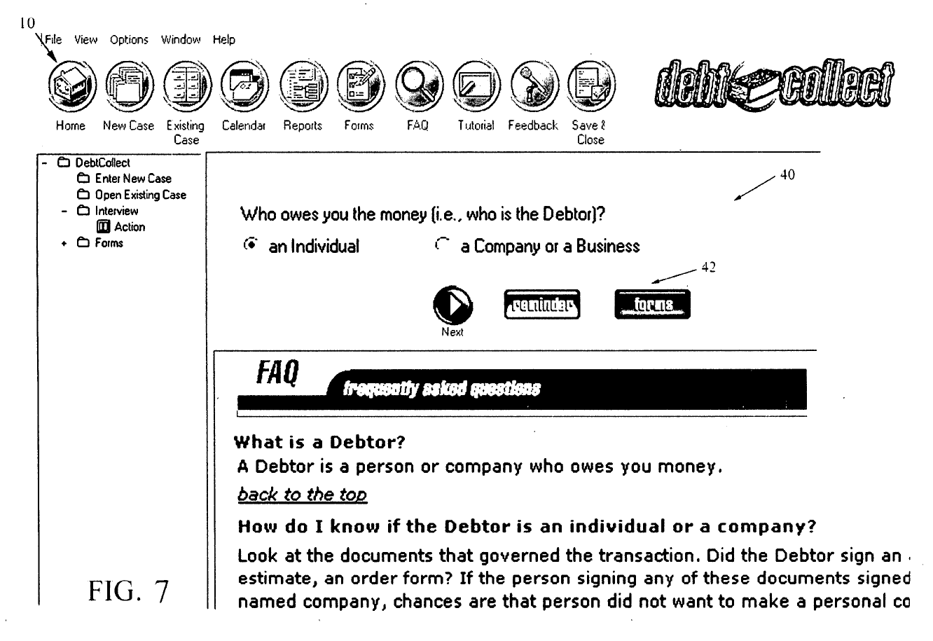

If the user presses the “Next” button the next sequential decision checklist 40 appears and the user is presented with the next array of questions which includes debtor information as shown in FIG. 7. Again, each decision is always visible in conjunction with advice directly beneath in the window at bottom right to assist the user in the interview, where FAQ Screen 50 provides advice on each choice in decision checklist 40.

The guided interview process continues until the user has completed all necessary information required for the selected option. For example, if a weak collection letter is selected then the user will need to identify the debtor, the amount of the debt, and complete an interest worksheet. “The Interview” is comprised of the following major sections which are derived from the method shown in FIG. 1:

A. Collecting Receivables

Contains all questions regarding the early status of a past due account or invoice. Actions include preparation and printing of three progressively assertive collections letters. The program will insert debtor(s), file or account number, amount of debt, and additional charges such as up-to-date interest or other fees.

B. Dealing with Bounced Checks

Contains questions and admonitions regarding a bounced check including a telephone call log and link to Notice of Dishonor.

C. Where to file suit?
If debtor signed a contract, does the contract or agreement specify that all disputes must be submitted to arbitration? (yes) (no)
   If yes, you will not be able to pursue this matter in small claims court unless the debtor who signed the contract agrees not to require arbitration.
Does the contract or agreement specify that in the event of a dispute, suit must be filed in a certain county or state? (yes) (no)
   If yes to above, where must suit be filed?
   Note: if not in MD, program should warn user that s/he will not be able to pursue this claim in MD absent agreement of debtor who signed agreement.
   Note: If County in MD is specified, program should automatically determine this county to be proper venue.
Did the debtor purchase goods or services for resale?
Did the debtor purchase the goods or services for use in a business or trade?
Was the transaction conducted in MD? If yes, what County?
Does the debtor regularly conduct business in MD? (repeat for each debtor) If so, what County?
Does the debtor live in MD? If so, what County? (repeat for each debtor)
Did the debtor sign the contract or reach the agreement in MD? If so, what County? (repeat for each debtor)

Based on answers to the foregoing, the user is provided with options as to where suit can be filed. If not in Maryland, the program so states. If in Maryland, the program use the answers to determine counties and courthouse locations. User is then prompted to select the most convenient courthouse from the options provided. The program then uses the address of the courthouse on the generated pleadings.

D. Should the User file suit?

The program solicits the date on which the debtor admitted owing the money? (Only necessary if answers above show last payment due date is more than three years ago). If payment was due more than 3 years ago, and there have been no payments on account and no admissions of the debt within the last three years, the program warns that it is likely that the Statute of Limitations has passed.

Has the debtor admitted to owing the money? (yes) (no)
If “yes” did the debtor admit it in writing or orally?
If in writing, was it in a: (1) letter; (2) memo; (3) other document—describe.
If in writing, do you still have the document for attachment to the Complaint? (If yes, the program should add this to the list of exhibits.)
Are there any other charges claimed against the debtor in this case?
How should the court papers served on the debtor(s)? (a radio box is displayed with options for return to user for service through private process or certified mail, or have court serve it through sheriff.) Note, the program here recommends return to plaintiff for certified mail, return receipt requested for all corporate debtors with known resident agents or for service.

E. Determine if the claim exceeds the small claim limit.

Based on the entered information, the software automatically determines if the claim exceeds the small claim limit. If so, and the plaintiff is an individual as opposed to a business the program displays that the claim may be pursued without an attorney, but it is not a “small claim” (meaning that discovery could be used). If so, and the plaintiff is a business, the program explains the two possible options (1) cutting the claim down to the small claim limit; or (2) getting an attorney.

F. Filing the Small Claims Court Complaint Form

The user is prompted to enter information sufficient to file this form, such as identifying the parties, on the amount of the debt, and the reason for the debt, as follows.
To whom is the money owed? (Drop down list)
Who owes the money? (Company or individual?)
If Individual, provide full name (middle not necessary) and address (street, not P.O. box)
If company, radio box check off for type—sole proprietorship, corporation, LLC, LLP, partnership, or don't know.
If don't know call official records for phone number, etc.
If sole proprietorship, enter name and address of business and owner
If partnership, name and address of partnership plus name of general partner
If corporation, LLC, LLP, or partnership, enter full, formal business name, address, and resident agent.
Note: a pop-up box is displayed strongly recommending a call to official state records to verify info.
If debtor is a corporation or LLC with no listing at official state records, enter full name and address of entity (program will fill automatically fill in Serve On: official state records with address.
Is anyone else responsible for the debt (personal guarantee, another company, etc.) If yes, the foregoing questions repeat.
How much is owed, total, exclusive of interest? (Note, if amount entered is over the small claims limit, a pop up warning is displayed.
Has the debtor made any payments to reach a balance or was that the total amount charged? (radio box: (1) yes, the debtor made payments; (2) no the debtor did not make any payments.
   If (1), how much did the debtor pay?
What was the date of the debtor's last payment?

At this point the program automatically calculates the Total amount due and asks the user: Is the total amount owed one lump sum or is it comprised of several different amounts (i.e., different jobs, assignments, or separate orders)?
If one lump sum, when was payment originally due? (calendar feature). Did you send an invoice? If so, what was it dated?
Are you charging interest? Simple or compound? If no, pop-up box notifies the user of the applicable law (e.g., Maryland allows for automatic charge of 6% interest on undisputed debts).
How much (automatically in percentage—fill in or up and down arrows by 0.25%)
How did you notify the debtor about your policy of charging interest? (drop down box: signed contract or agreement, estimate, posted policy, other document, or did not notify).
If signed contract or agreement or other document, name of document, if any (i.e., commercial account agreement), and date of agreement
If user did not notify the debtor that interest was being charged, screen should warn that plaintiff does not have a case to recover interest except at state's default rate of 6%. “Would you like to charge 6%?”

Are there any other charges for which you are holding the debtor responsible?
If yes, amount and description (i.e., “restocking fee”). The software repeats the “how did you notify” dialogue above
Why does the debtor owe you money? (radio box with multiple choice's OK—(1) sold goods; (2) performed services (includes the rental of assets); (3) bounced check; (4) other?
If sold goods, have you listed them in (radio box: (1) invoice; (2) contract or agreement; (3) letter; (4) other document; (5) they are not separately listed. Note: Throughout the interview, whenever the user indicates that a document exists (i.e., a contract, an invoice, etc.) the program uses that document to compile a suggested exhibit list for attachment to the Complaint. If (5) is chosen, a notice appears advising user that s/he should list the goods sold to the debtor(s) as an attachment to the Complaint.
If performed services, describe the services performed to complete the sentence: “As agreed by the parties, <user> ______ for the debtor. (i.e., “performed accounting services”). Note: If “a combination of both” was the response, the program uses both responses in compiling the Complaint.
If “other” is response, the user is asked to describe how s/he earned the money claimed in this account by putting into the sentence “As agreed by the parties <user> ______ for which debtor(s) agreed to remit the payment claimed.
If bounced check, date and amount of check, plus bank name on account, and account number (for later execution on judgment).
If bounced check, did you send a Notice of Dishonor? (yes) (no)
If “yes” give date of notice.
If “yes” how did you deliver it to debtor? (radio button: (1) hand delivery; (2) certified mail, return receipt requested; (3) first class mail; (4) certified mail, no return receipt requested; (5) other. If (1), indicate date of delivery. If (2), date on return receipt indicating delivery. If 3, 4, or 5, program suggests methods 1 or 2 so that debtor's receipt can be verified. Dialogue box should appear with “would you like to prepare and send one now?”
Have you assessed any charges against the debtor for a bounced check? (yes) (no)
If “yes,” how is debtor notified of the policy?
Do you still have the check or a front and back copy of it? (yes) (no). If yes, program notes this for use in a list of “critical documents.”
What was the last date on which you delivered the goods or performed the services for which you are now seeking payment? (a pop-up entry calendar function is displayed)
Did you complete your end of the bargain? (yes) (no)

G. Handling Defendant's Response

This section of the interview explains how to handle each form of defendant response that may result from filing the court claim. Links are provided to select the proper response letter or motion.

H. Settling the Claim

This section of the interview guides the user and collects information necessary to settle the claim, with links provided to appropriate text sections and to the forms, letters and worksheets including:
Case Value Worksheet
Motion for Postponement
Consent Judgment
Order of Satisfaction
Promissory Note
Notice of Dismissal
Stipulation of Dismissal

1. Preparing for Court Appearance

This section of the interview explains how and provides links to the tools, such as:
Sample Power of Attorney
Checklist of Exhibits required for an effective court result
Print function for all relevant case information entered into the system including:
Collection Letters
Telephone contacts and notes
Interest worksheet
Complaint Form
Witness list with Point, Question and Exhibit

J. Appearing in Court

This section of the interview describes how to find the right courtroom, a sample docket sheet and where to locate, and what to expect in court.

K. Getting Money After Winning the Case

This section of the interview guides the user and collects information necessary to actually get paid. Links to complete descriptions and example documents required to:
Record Judgment
Find debtor assets and income sources
Collect the Money

If judgment has been awarded, the interview asks for the following details:

Amount of judgment?

Date of judgment?

Court in which judgment awarded (County)?

Pre-judgment interest allowed?

Other costs awarded as part of judgment?

A dialogue box then shows options for executing on a judgment in Maryland. One can either proceed through post-judgment discovery or move directly to (1) attaching bank account(s); (2) garnishing wages; (3) selling debtors' personal property; or (4) selling debtor's real property. The user is then prompted to select an option for executing on the judgment:
Post-judgment discovery (Boilerplate. Can be generated immediately with no further information gathered from user)
Attach debtor's bank account
Garnish debtor's wages
Sell debtor's personal property
Sell debtor's real property

Any further information necessary for executing on the judgment is collected. The software screens the data and points out any constraints. For example, if “garnish wages” is selected the user is warned that this is not for use for military personnel, except it can be used to garnish military retirement funds.

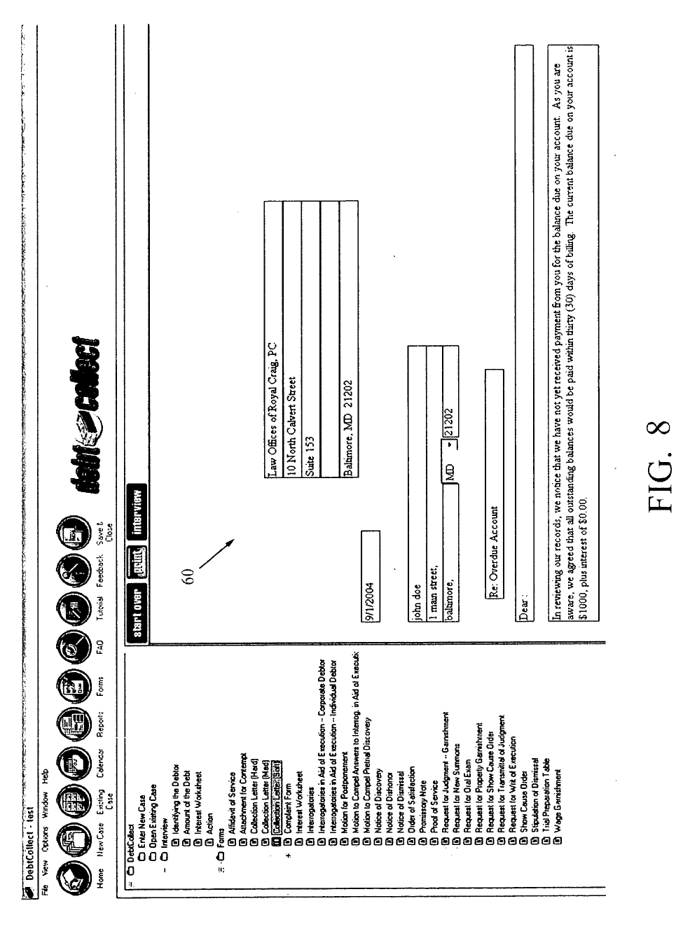

Once the user has navigated the relevant sections of the guided interview as set forth above, the FAQ section of the screen is replaced by a word processing section 60 as shown in FIG. 8 and the relevant document is generated in editable format (and can be printed). Throughout the entire interview process a validation engine is applied so that data and business rules are validated as information is entered into the system. Example of real time data validation include:
Real time data integrity checks: the user must enter a value for all required fields before the final form, letter or other output can be printed. In some instances, warnings are provided so that printing is not stopped, incase information will be tilled in manually.
Specific field format validation (e.g. date fields entered into the system in the format mm/dd/yyyy.

Examples of business rule validation include:
Defendant must be identified before filing complaint.
Claim worksheet must be completed in order to determine filing location.
All required data elements must be completed prior to a “final” version of a form being printed

Also throughout the process the software selectively applies a rule-based decision engine to the entered data to prescreen potential problems or to give special advice. For example, as the date of the claim is entered the rule-based decision engine will determine if the claim is too old. If payment was due more than 3 years ago, and there have been no payments on account and no admissions of the debt within the last three years, the program warns that it is likely that the Statute of Limitations has passed. Similarly, the program warns if the claim exceeds the small claim limit. If so, and the plaintiff is an individual as opposed to a business, the program states that the claim may be pursued without an attorney, but it is not a “small claim” (meaning that discovery could be used). If so, and the plaintiff is a business, the program explains the two possible options (1) cutting the claim down to the small claim limit; or (2) getting an attorney.

Referring back to FIG. 2, it is seen that experienced users may choose to bypass the Guided Interview and proceed instead to the Forms Fast Lane at step 136. The Forms Fast Lane is designed for people who know the process and want to go straight to a form, letter or document and skip the step-by-step interview process. If the Forms Fast Lane option is selected, a list of available forms is shown as in FIG. 8 to the left in folder/subfolder format. The selected form is displayed in word processing screen 60 with any pre-entered information filled into editable fields. Currently, any of the following forms may be selected:

A. Collections
1. First Collection letter
2. Second Collection Letter
3. Final Collection Letter
4. Sample Notice of Dishonor

B. Filing a claim
5. Claim Worksheet
6. District Court Complaint
7. Interest Worksheet
8. Letter of Transmittal to Civil Clerk
9. Sample Affidavit of Service
10. Sample Motion for Postponement
11. Sample Letter of Confirmation to Defendant

C. Settlement
12. Order of Satisfaction
13. Notice of Dismissal
14. Stipulation of Dismissal
15. Sample Promissory Note
16. Sample Motion for Postponement

D. Court Appearance
17. Trial Preparation Table
18. Limited Power of Attorney
19. Request to File Notice of Judgment Letter
20. Request for Transmittal of Judgment

E. Collecting the Judgment
21. Interrogatories in Aid of Execution
22. Request for Order for Defendant to Appear for Examination in Aid of Enforcement of Judgment
23. Motion to Compel Discovery
24. Show Cause Order
25. Request for Show Cause for Contempt
26. Attachment for Contempt
27. Request for Property Garnishment
28. Wage Garnishment Form
29. Request for Writ of Execution
30. Judgment Creditors Monthly report
31. Order of Satisfaction

Thus, for example, to file a complaint directly, the user would select the District Court Complaint form (B)(6), complete the required fields, save it and print. Data entered in these forms is saved to the database for later us in future steps of the collection process.

Looking back at FIG. 2, the user may pick up a previously-saved interview where he left off the previous session by opening an existing case at step 140. This displays a lookup table that allows searching and retrieval of existing records from the database.

The user also has a full REPORTS option at step 160 which provides several reports which summarize the status of cases, the amount of the claim and the defendant. This includes a basic Case Report that shows:
Reference Name
Reference Number
Case Name
Amount Claimed
Status
If in Settlement: Terms
Amount Received to date
Balance due
Remarks
Report Date

Other reports include summaries, date selections etc. derived from the database.

Regarding FIG. 2, the user also has FORMS option at step 170 which allows direct viewing and/or printing of any of the stored forms (blank) upon demand.

The user may also view and navigate the FAQs section at step 180, or take a full tutorial of the software at step 190.

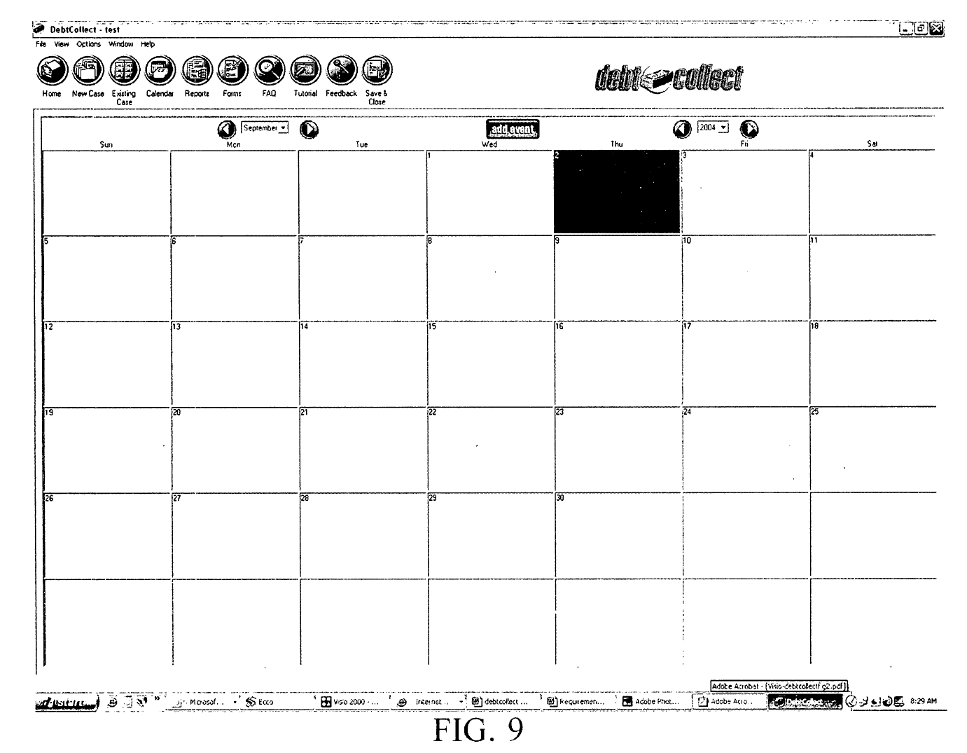

Finally, at step 150, the user may select a graphical calendar option which engenders a navigable monthly calendar as shown in FIG. 9. All critical dates from the database show through to allow scheduling, and the user may enter other EVENT dates by depressing the “Add Event” button at top.

As described previously, data entered in the interview and in the forms is saved to a database for use in the collection process.

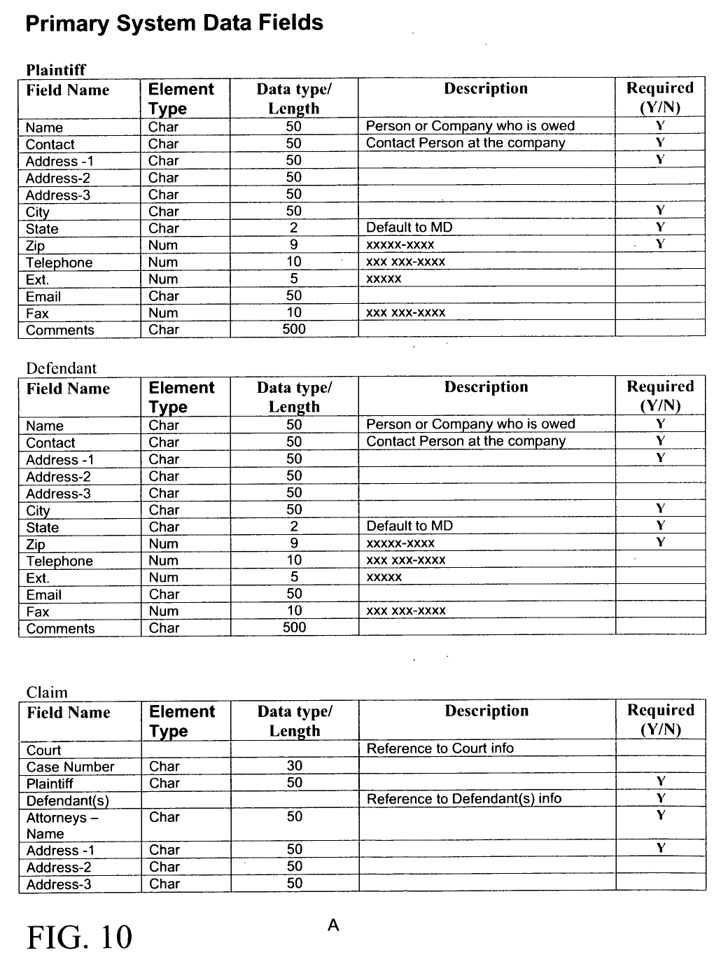

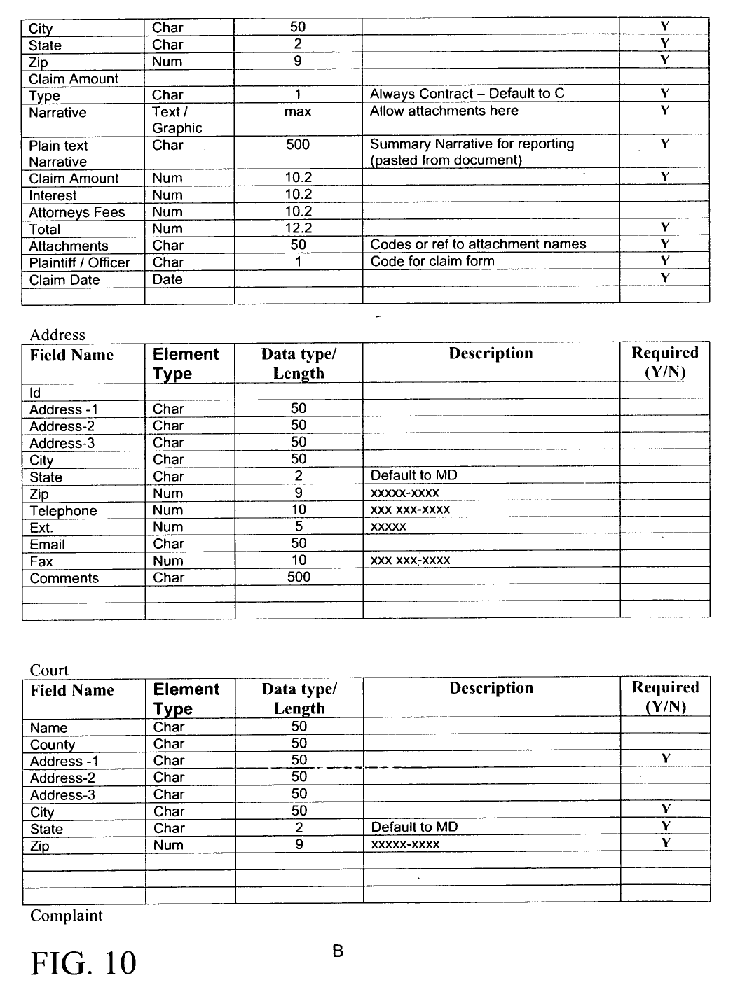

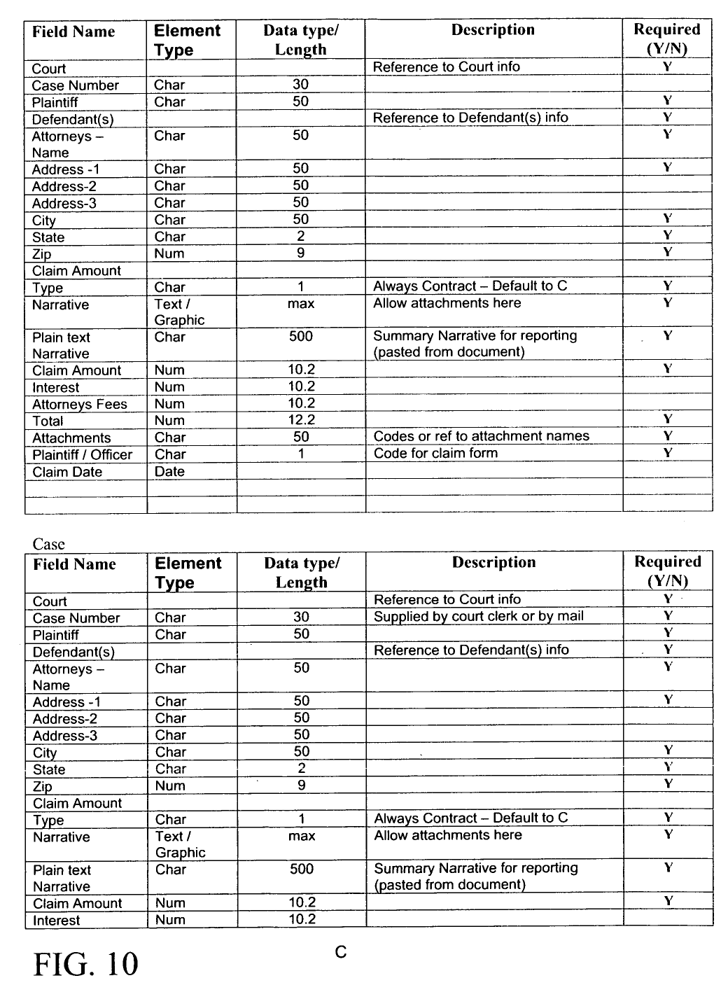

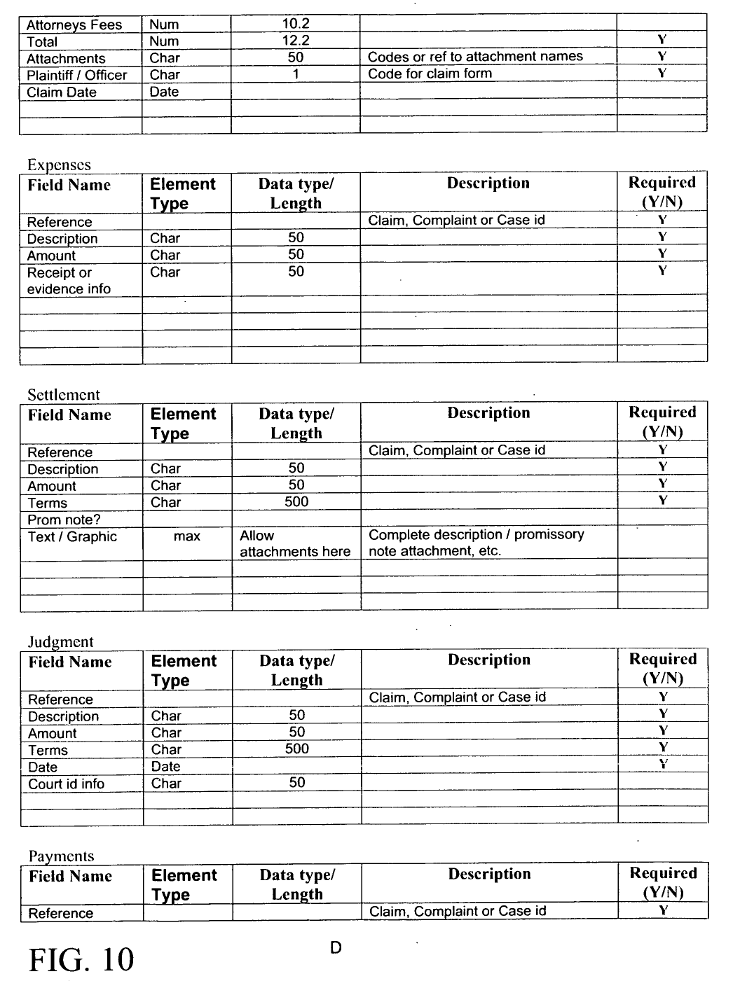

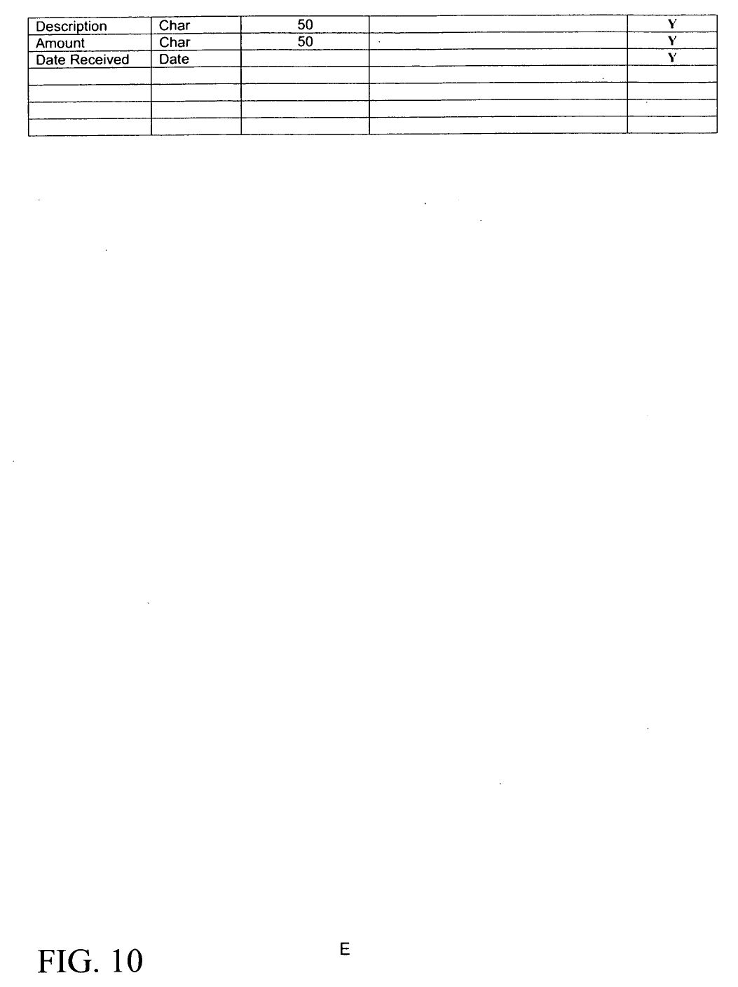

FIGS. 10a-e illustrate the database arrangement inclusive of separate tables, Field Names, Data Element Types, Data type/Length, Data Descriptions, and whether this is a Required Field (Y/N) for validation.

It should now be apparent from the foregoing that the present software system allows inexperienced users to service debts, and quickly increases debt servicer effectiveness while decreasing the time and expense necessary to process a collection effort in accordance with ever-changing court forms and regulations, UCC-compliance, etc., thereby adding consistency and quality to a businesses' collection efforts.

Having now fully set forth the preferred embodiments and certain modifications of the concept underlying the present invention, various other embodiments—as well as variations and modifications of the embodiments herein shown and described-obviously will occur to those skilled in the art upon becoming familiar with said underlying concept. It is to be understood, therefore that the invention may be practiced otherwise than as specifically set forth in the appended claims.

I claim:

1. A program product for facilitating a collection program tangibly embodying a program of machine-readable instructions executable by a computer system having an operating system, comprising:
a guided interview for guiding a debt servicer through data entry via a series of questions including nature of the debt due, type of work performed or goods sold, person or company who owes the debt, and terms under which the work was performed or goods sold;
a direct-form entry selection for allowing the debt servicer to enter data directly into editable forms bypassing said guided interview;
a database for storing entered data; and
a word processing module for compiling and editing said editable forms using said entered data.

2. The program product according to claim 1, further comprising a graphical user interface which serves as a gateway to begin a new collection case, open an existing collection case, view a calendar of consolidated collection cases, view reports, edit forms, view frequently-asked questions, and take a tutorial.

3. The program product according to claim 2, wherein said graphical user interface provides a selection to the debt servicer as to whether to enter information about a case via said guided interview or said direct-form entry selection.

4. The program product according to claim 1, wherein said guided interview comprises a series of screens that guide the debt servicer through an information collection and debt recovery process step by step.

5. The program product according to claim 1, wherein said direct-form entry selection comprises direct data entry into editable forms for collection.

6. The program product according to claim 4, wherein said guided interview screens provide advice to assist the user in entering data.

7. The program product according to claim 6, wherein said guided interview screens further comprise screens from among a group consisting of collecting receivables, dealing with bounced checks, where to file suit, should the user file suit, determining if a claim exceeds a statutory small claim limit, filing the small claims court complaint form, handling defendant's response, settling the claim, preparing for court appearance, appearing in court, and getting money after winning the case.

8. The program product according to claim 1, further comprising a data validation engine to validate data entry.

9. The program product according to claim 8, wherein said data validation engine further comprises real time data integrity checks, specific field format validations, and business rule validations.

10. The program product according to claim 1, further comprising a library of editable forms.

11. The program product according to claim 10, wherein said library of editable forms further comprises three collection letter including each of a “Soft”, “Medium” and “Final” collection letter.

12. The program product according to claim 7, wherein said guided interview screens all comprise a uniform interface including one-click action buttons at top for easy access, and a user-navigation trail displaying folder and subfolders.

13. Software for facilitating a collection program, comprising:
a graphical user interface for allowing a user to begin a new collection case or open an existing collection case, and to select between a guided interview and direct form entry;
a library of collection forms;
a graphical guided interview comprising a sequence of screens for guiding said user through data entry via a series of questions including nature of the debt due, type of work performed or goods sold, person or company who owes the money, and terms of the transaction, said data used for populating said forms;
a word processing module for said direct-form entry that allows the debt servicer to enter data directly for populating said collection forms, bypassing said guided interview;
compiling forms using said data.

14. The software according to claim 13, wherein said graphical guided interview comprises a series of user screens that guide the debt servicer through an information collection and debt recovery process step by step by informational narrative appearing on said screens.

15. The software according to claim 14, wherein said direct-form entry selection comprises direct data entry into editable forms in said library of forms.

16. The software according to claim 15, wherein said library of forms includes court documents.

17. The software according to claim 14, wherein said guided interview screens further comprise screens from among a group consisting of collecting receivables, dealing with bounced checks, where to file suit, should the user file suit, determining if a claim exceeds a statutory small claim limit, filing the small claims court complaint form, handling defendant's response, settling the claim, preparing for court appearance, appearing in court, and getting money after winning the case.

18. The software according to claim 13, further comprising a data validation engine to validate data entry, said data validation engine further comprises real time data integrity checks, specific field format validations, and business rule validations.

19. The software according to claim 16, further comprising a rules-based engine for automatically determining if a collection case exceeds a small claim limit, and for determining where said court documents can be filed in respect to specific counties and courthouse locations.

20. A software method for administering collection cases, comprising the steps of:
providing a graphical user interface for guiding a user through data entry regarding a collection case;
providing a graphical user interface for advising said user on possible collection efforts and techniques used prior to filing a lawsuit, including collection letters of various levels of severity, options to be pursued if a debtor's check is returned unpaid, and settling the collection case;
providing, a graphical user interface for guiding said user through implementation of lawsuit if collection efforts fail, and for automatically generating court documents for implementing said lawsuit;
providing a graphical user interface for guiding said user through actual collection on a judgment by garnishing bank accounts and wages, attaching and selling property, and investigating assets.
